(19) United States
(12) Patent Application Publication
(10) Pub. No.: US 2015/0341237 A1
(43) Pub. Date: Nov. 26, 2015

(54) Binning of Network Transactions in a Storage Area Network

(71) Applicant: Virtual Instruments Corporation, San Jose, CA (US)

(72) Inventors: Genti Cuni, Mountain View, CA (US); Nicholas York, San Ramon, CA (US); Ana Bertran Ortiz, San Francisco, CA (US)

(73) Assignee: Virtual Instruments Corporation, San Jose, CA (US)

(21) Appl. No.: 14/285,494

(22) Filed: May 22, 2014

(51) Int. Cl. H04L 12/26; G06F 12/08; H04L 29/08

(52) U.S. Cl. CPC H04L 43/067; H04L 43/16; H04L 67/1097; G06F 12/0891

(57) ABSTRACT

A monitoring system maintains multiple counts. Each of these counts is associated with a range and indicates a number of network transactions that occurred in a storage area network (SAN) during a time period with values that are within the associated range. When the monitoring system identifies the occurrence of a network transaction between devices in the SAN, the monitoring system determines a time duration and/or a size of the network transaction. The monitoring system identifies a count associated with a time range that includes the determined time duration and increments the identified count. Additionally, the monitoring system identifies a count associated with a size range that includes the determined size and increments the identified count.

### BACKGROUND

1. Technical Field

The described embodiments pertain in general to data networks, and in particular to tracking network transactions in a storage area network, such as time duration and size of network transactions.

2. Description of the Related Art

A storage area network (SAN) is a data network through which servers communicate with storage devices for storing and retrieving block level data. One indicator of how well a SAN is performing is the amount of time it takes for the completion of network transactions between devices in the SAN. A network transaction may be, for example, a server reading from a storage device or writing to a storage device. In a large SAN, a high number of network transactions are constantly occurring. Due to the high number of network transactions, tracking, analyzing, and storing the time duration of each transaction can be a very resource intensive task.

### SUMMARY

The described embodiments provide methods, computer program products, and systems for tracking metrics of network transactions in a storage area network (SAN). A monitoring system maintains multiple counts. Each of these counts is associated with a time range and indicates a number of network transactions that occurred in the SAN during a time period with time durations that are within the associated time range. When the monitoring system identifies the occurrence of a network transaction between devices in the SAN, the monitoring system determines a time duration of the network transaction. The monitoring system identifies a count associated with a time range that includes the determined time duration and increments the identified count. At the end of the time period, the monitoring system transmits the value of each count to an information system for storage. The count values are made available to users for access.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram of a monitored storage area network (SAN) according to one embodiment.

FIG. 2 is a block diagram illustrating an example of a network of switch fabrics according to one embodiment.

FIG. 3 is a block diagram illustrating modules within an information system according to one embodiment.

FIG. 4 is a flow diagram of a process for tracking time duration of network transactions according to one embodiment.

FIG. 5 is a block diagram illustrating components of an example machine according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

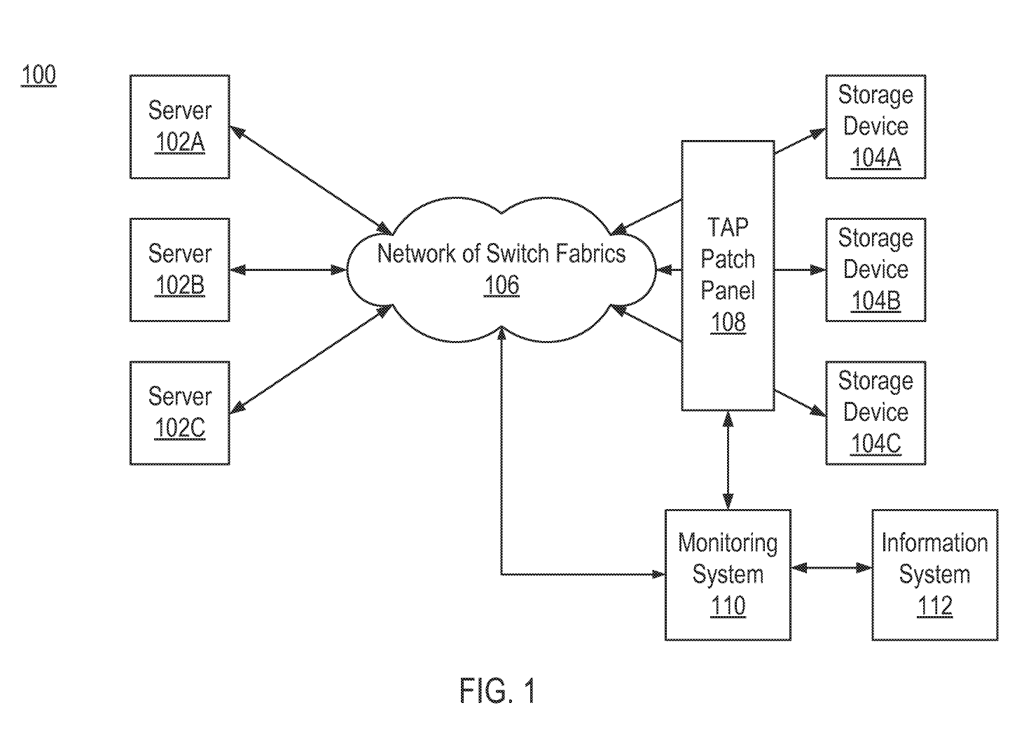

FIG. 1 is a block diagram of a monitored storage area network (SAN) 100 according to one embodiment. The SAN 100 includes three servers 102A, 102B, and 102C and three storage devices 104A, 104B, and 104C. The servers 102 and the storage devices 104 are connected via a network of switch fabrics 106. Although the illustrated SAN 100 only includes three servers 102 and three storage devices 104, other embodiments can include more of each entity.

FIG. 1 uses like reference numerals to identify like elements. A letter after a reference numeral, such as “102A,” indicates that the text refers specifically to the element having that particular reference numeral. A reference numeral in the text without a following letter, such as “102,” refers to any or all of the elements in the figures bearing that reference numeral (e.g. “102” in the text refers to reference numerals “102A,” “102B,” and/or “102C” in the figures).

A server 102 is a computing system that has access to the storage capabilities of the storage devices 104. A server 102 may provide data to a storage device 104 for storage and may retrieve stored data from a storage device 104. Therefore, a server 102 acts as a source device when providing data to a storage device 104 and acts as a destination device when requesting stored data from a storage device 104.

A storage device 104 is a storage system that stores data. In one embodiment, a storage device 104 is a disk array. In other embodiments, a storage device 104 is a tape library or an optical jukebox. When a storage device 104 receives a request from a server 102 to store data, the storage device 104 stores the data according to the request. When a storage device 104 receives a request from a server 102 for stored data, the storage device 104 retrieves the requested data and transmits it to the server 102.

The servers 102 and the storage devices 104 communicate and exchange data via the network of switch fabrics 106. The network of switch fabrics 106 includes one or more fiber channel switch fabrics. Each fabric of the network 106 includes one or more fiber channel switches that route data between devices. Several communication channels exist between the devices (e.g., servers 102, storage devices 104 and switches) included in the SAN 100. The communication channels are mediums through which signals are transported between devices. Communication channels are also referred to as “links” herein.

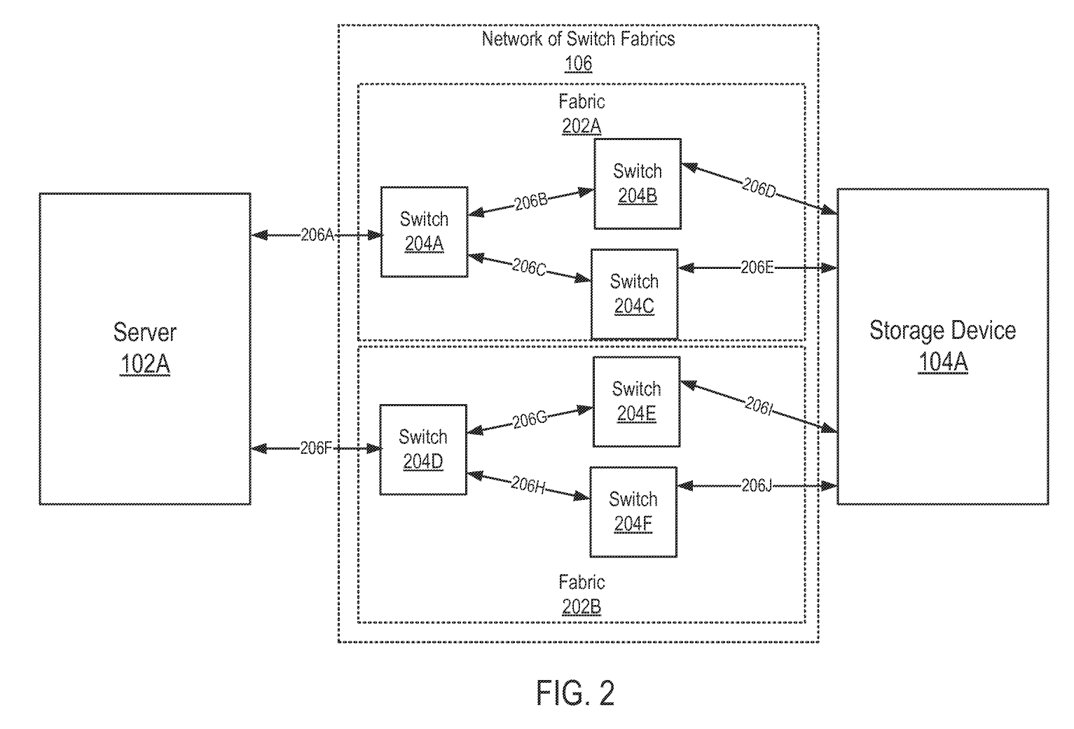

FIG. 2 illustrates an example of the network 106 and the links between server 102A and storage device 104A. In the example of FIG. 2, the network of switch fabrics 106 includes two fabrics 202A and 202B. Fabric 202A includes switches 204A, 204B, and 204C. Fabric 202B includes switches 204D, 204E, and 204F. As can be seen in FIG. 2, several links 206A-206J connect the server 102A to the storage device 104A. For example, in fabric 202A, links 206A, 206B, and 206D connect the server 102A to the storage device 104A through switches 204A and 204B. As another example, in fabric 202B, links 206F, 206H, and 206J connect the server 102A to the storage device 104A through switches 204D and 204F.

Returning to FIG. 1, the monitored SAN 100 also includes a traffic access point (TAP) patch panel 108, a monitoring system 110, and an information system 112. The TAP patch panel 108 is a hardware device inserted between the server 102 and the storage device 104. The TAP patch panel 108 diverts at least a portion of the signals being transmitted along certain links to the monitoring system 110. In one embodiment, the links for which signals are diverted are selected by a system administrator.

In one embodiment, the links in the SAN 100 are optical fibers and the network communications traveling on the optical fibers are provided via optical signals. The optical signals are converted to electrical signals at various devices (e.g., a server 102, a storage device 104, and the monitoring system 110). According to this embodiment, the TAP patch panel 108 operates by diverting for certain links a portion of light traveling on a link to an optical fiber connected to the monitoring system 110.

The monitoring system 110 is a computing system that collects (e.g., measures and/or calculates) metrics associated with entities in the SAN 100. In one embodiment, the monitoring system 110 is the VirtualWisdom SAN Performance Probe provided by Virtual Instruments Corporation of San Jose, Calif. The entities for which the monitoring system 110 collects metrics may be any device or component in the SAN 100, such as links, servers 102, storage devices 104, switches, ports of devices, etc.

In one embodiment, software probes run on the monitoring system 110 and utilize standard protocols to poll devices in the SAN (e.g., servers 102, storage devices 104, and switches) for available metrics of the devices, such as metrics that describes network traffic (e.g., data transmission rates at different times and percentage of time devices spent with zero buffer-to-buffer credits), event counters, CPU and memory usage, and other types of configuration information.

Additionally, the monitoring system 110 analyzes the signals received from the TAP patch panel 108. Based on the analyzed signals, the monitoring system 110 collects metrics for links in the SAN 100, including traffic data that describes network traffic on the links.

In one embodiment, as part of collecting metrics, the monitoring system 110 analyzes signals received from the TAP patch panel 108 to identify network transactions occurring between devices of the SAN 100 (e.g., between servers 102 and storage devices 104). Specifically, based on the signals received from the TAP patch panel 108, the monitoring system 110 determines when a network transaction between devices in the SAN 100 is initiated and a time associated with the initiation of the transaction. The monitoring system 110 also determines when the network transaction ends and a time associated with the ending of the transaction. The monitoring system 110 determines the time duration of the network transaction by calculating the difference between the time associated with the ending and the time associated with the initiation of the transaction. In one embodiment, the monitoring system 110 also determines the size of network transactions (e.g., in bytes) based on the signals. In one embodiment, the monitoring system 110 may also identify and determine the time duration and size of network transactions based on metrics obtained by the software probes.

The network transactions identified by the monitoring system 110 and for which the system 110 determines time durations and size may include, exchange completion transactions. An exchange completion transaction is the completion of an exchange between devices in the SAN 100. Examples of exchange completion transactions include read exchange completion transactions and write exchange completion transactions.

A read exchange completion transaction involves a device (e.g., a server 102) issuing a read request for an item (e.g., a file or a group of files) to another device in the SAN 100 (e.g., a storage device 104) and the issuing device completing the reading of the item from the other device. Therefore, the time duration of the read exchange completion transaction, which may also be referred to as the read exchange completion time, is the total time it takes to read the item. A write exchange completion transaction involves a device (e.g., a server 102) issuing a write request of an item to another device in the SAN 100 (e.g., a storage device 104) and the item being completely written/stored by the other device. The time duration of the write exchange completion transaction, which may also be referred to as the write exchange completion time, is the total time it takes to write/store the item.

A network transaction may also be a component/phase of an exchange between devices. For example, a network transaction may involve a device receiving a first packet of an item after issuing a read request for the item. In this example, the time duration of the transaction is the total time it takes for the device to receive the first packet after issuing the read request. As another example, a network transaction may involve a device writing/storing a first packet of an item after a write request is issued. In this example, the transaction time duration is total time it takes for the first packet to be written/stored after the write request is issued.

The monitoring system 110 maintains multiple counts. In one embodiment, the monitoring system 110 maintains certain counts where each count is associated with a time range (which may also be referred to as a “time range bin”) and one or more transactions types. Each of these counts indicates a number of network transactions of the associated one or more types that have occurred in the SAN 100 during a time period with time durations that are within the associated time range. For example, the monitoring system 110 may maintain a set of counts for tracking time duration of read exchange completion transactions, a set of count of counts for tracking time duration of write exchange completion transactions, and a set of counts for tracking time duration of all transactions identified by the monitoring system 110 regardless of type. Within each set of counts, each count is associated with a different time range.

When the monitoring system 110 identifies a network transaction and determines a time duration for the transaction, the monitoring system 110 identifies one or more counts associated with a time range that includes the time duration of the transaction and associated with the type of the transaction. The monitoring system 110 increments the identified count by a value of one. Therefore, the monitoring system 110 is binning the transactions based on their time duration and using time ranges as bins.

As an example, assume a write exchange completion transaction is identified by the monitoring system 110 with a write exchange completion time of X milliseconds. The monitoring system 110 may increment a count that tracks a total number of network transactions that occur in the SAN 100, regardless of type, with time durations within a range that includes X milliseconds. The monitoring system 110 may also increment a count that tracks only write exchange completion transactions with time durations within a range that includes X milliseconds.

In one embodiment, after a certain time period (e.g., after a one minute time period), the monitoring system 110 transmits as metrics to the information system 112, the current value of each count maintained and resets the counts to a value of zero. In other words, the monitoring system 110 periodically transmits to the information system 112 count values accumulated by the monitoring system 110 during a period of time and resets the counts so that the counting can begin for a new time period.

With each count value transmitted to the information system 112, the monitoring system 110 includes information with regards to the time range associated with the count and the time period during which the count was accumulated. For example, the monitoring system 110 may transmit information to the information system 112 indicating that between the 10:35 AM and 10:36 AM time period, the number of network transactions in the SAN 100 with time durations between 0 and 0.10 milliseconds was X, the number of transactions with time durations between 0.11 and 0.20 milliseconds was Y, etc. The monitoring system 110 also periodically transmits to the information system 112 other metrics collected by system 110, as described above.

On a single link, thousands of network transactions may be occurring every second. Therefore, informing the information system 112 of metrics of each individual transaction (e.g., time duration) is not feasible. However, by binning the transactions, the monitoring system 112 can provide metrics of network transactions to the information system 112 that describe the performance of the SAN 100.

Although the monitoring system 110 is described as counting/binning time durations of network transactions using time ranges, it should be understood that other metrics collected by the monitoring system 110 may similarly be counted/binned. The monitoring system 110 may maintain counts for other types of metrics of network transactions, such as sizes of network transactions. Each of these counts is associated with a range and a type of metric. When a network transaction is identified and the monitoring system 110 determines a metric of the network transaction, the monitoring system 110 increments a count associated with the type of the metric and associated with a range that includes the determined metric.

As an example, the monitoring system 110 may maintain counts to track the size of network transactions. Each of these counts is associated with a size range and one or more transaction types. When the monitoring system 110 identifies a network transaction and determines the size of the network transaction, the monitoring system 110 increments one or more counts associated with a size range that includes the size of the transaction and associated with the type of the transaction.

The information system 112 is a computing system that makes metrics collected for the SAN 100 available to users for access. When the information system 112 receives metrics from the monitoring system 110, the information system 112 stores the metrics. The stored metrics include values of counts maintained by the information system 112. When a user requests information on the duration of network transactions during a certain time period, the information system 112 retrieves stored values of counts accumulated during the time period for the requested network transactions. The retrieved count values are transmitted by the information system 112 to a user device for presentation to the user.

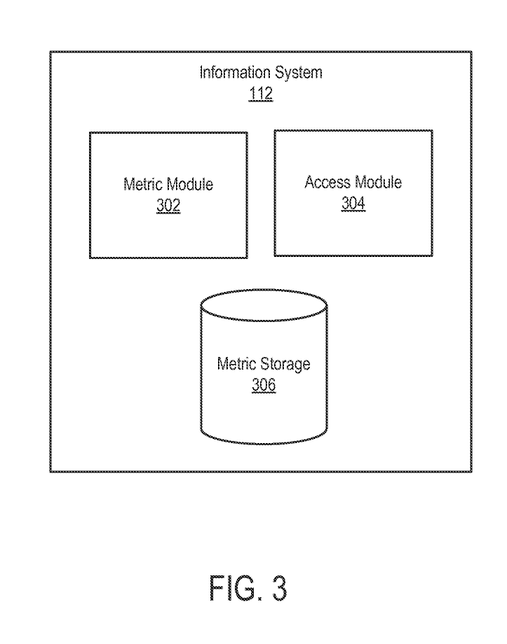

FIG. 3 is a block diagram illustrating modules within the information system 112 according to one embodiment. The information system 112 includes a metric module 302, an access module 308, and a metric storage 306. Those of skill in the art will recognize that other embodiments can have different and/or other modules than the ones described here, and that the functionalities can be distributed among the modules in a different manner.

The metric module 302 processes metrics received from the monitoring system 110. When metrics collected by the monitoring system 110 are received from the monitoring system 110, the metric module 302 stores the metrics in the metric storage 306. The metrics stored in the metric storage 306 include count values of network transactions that occurred during different time periods. Each count value is associated with a range, a time period, and one or more types of network transactions. Each of these count values is a number of one or more types of network transactions that occurred in the SAN 100 during the associated time period with values that are within the associated range.

The access module 304 process requests from users to access stored metrics. When a user requests from the information system 112 information on, for example, the time duration of network transactions, the user indicates the one or more types of network transactions for which the user would like time durations (e.g., all identified network transactions, read exchange completion transactions, write exchange completion transactions). The user also indicates a time period that the user is interested in as to when the transactions occurred (referred to as the “requested time period” herein).

Based on the user request, the access module 304 identifies count values stored in the metric storage 306 for the requested types of network transactions and that are associated with time periods that are within the requested time period. For example, if the user requests duration times for read exchange completion transactions between 7:00 PM and 7:30 PM, the access module 304 identifies count values stored in the storage 306 for read exchange completion transactions that occurred any time between 7:00 PM and 7:30 PM.

In one embodiment, the access module 304 transmits the identified count values to a user for presentation. Each count value is presented along with the time range and time period associated with the count value. The count values may be presented to the user, for example, in a list or in graph form.

In another embodiment, the access module 304 aggregates the identified count values based on the associated time ranges. Aggregating count values based on time ranges involves the access module 304 identifying different times ranges with which the identified count values are associated. For each distinct time range, the access module 304 selects, from the identified counts, counts associated with the time range. The access module 304 aggregates the selected count values to generate an aggregate value for the time range. The access module 304 transmits the aggregate value of each time range to a user device for presentation to the user.

Continuing with the example from above, assume based on the request for duration times for read exchange completion transactions between 7:00 PM and 7:30 PM, the access module 304 identifies, a count value for a time period between 7:00 PM and 7:01 PM, a count value for a time period between 7:01 PM and 7:02 PM, a count value for a time period between 7:02 PM and 7:03 PM, and so forth with one minute intervals until 7:30 PM. Each of these count values associated with the same time range bin (other count values would also be identified for other time range bins). In this embodiment, instead of presenting each count value associated with the time range bin, the access module 304 aggregates the count values and presents the aggregate value for the time range bin. The aggregate value indicates the number of exchange completion transactions that occurred between 7:00 PM and 7:30 PM with time durations that are within the time range bin.

As the access module 304 is described as providing information on count values for time durations of network transactions, the access module 304 can similarly provide to a user information on count values for different metrics of network transactions (e.g., size of network transactions).

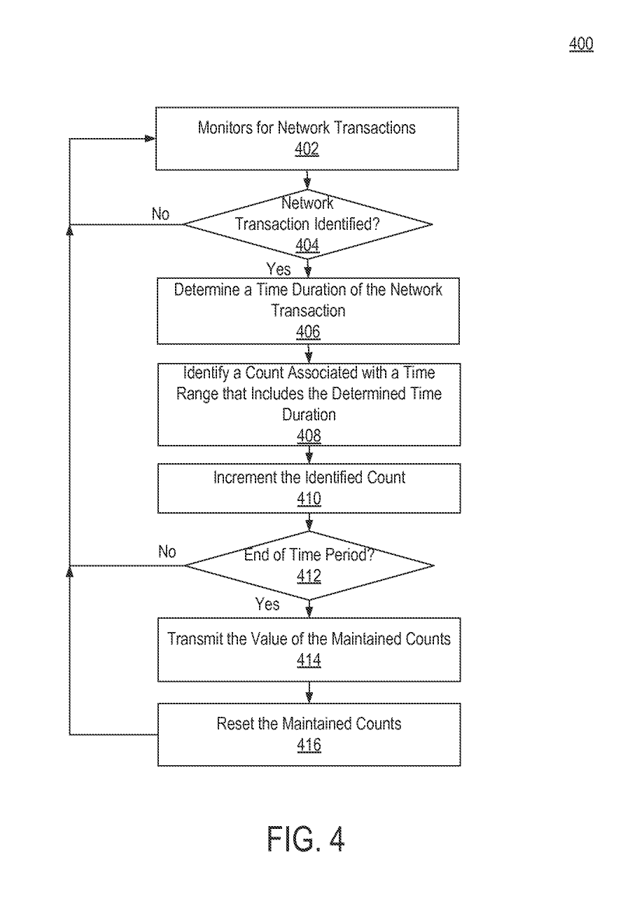

FIG. 4 is a flow diagram of a process 400 performed by the monitoring system 110 for tracking time duration of network transactions according to one embodiment. Those of skill in the art will recognize that other embodiments can perform the steps of FIG. 4 in different orders. Moreover, other embodiments can include different and/or additional steps than the ones described herein.

Assume for this example, that the monitoring system 110 maintains multiple counts. Each count is associated with one or more types of network transactions and a time range. A count indicates a number of network transactions of one or more types that have occurred in the SAN 100 during a time period with time durations within the associated time range.

The monitoring system 110 monitors 402 for the occurrence of network transactions by analyzing signals from the TAP patch panel 108. If a network transaction is identified 404, the monitoring system 110 determines 406 a time duration of the network transaction. The monitoring system 110 identifies 408 a count associated with a time range bin that includes the determined time duration and associated with the type of the identified transaction. The monitoring system 110 increments 410 the identified count by a value of one.

The monitoring system 110 determines 412 whether the end of the time period has been reached. If the end of the time period has not been reached, the process 400 return to step 402. On the other hand, if the end of the time period is reached, the monitoring system 110 transmits 414 the current value of each maintained count to the information system 112. The monitoring system 110 resets 416 the maintained counts and the process 400 returns to step 402.

Although processes for tracking network transactions have been described herein in a storage area network environment, it should be understood that the processes can be applied to other network environments.

### Computing Machine Architecture

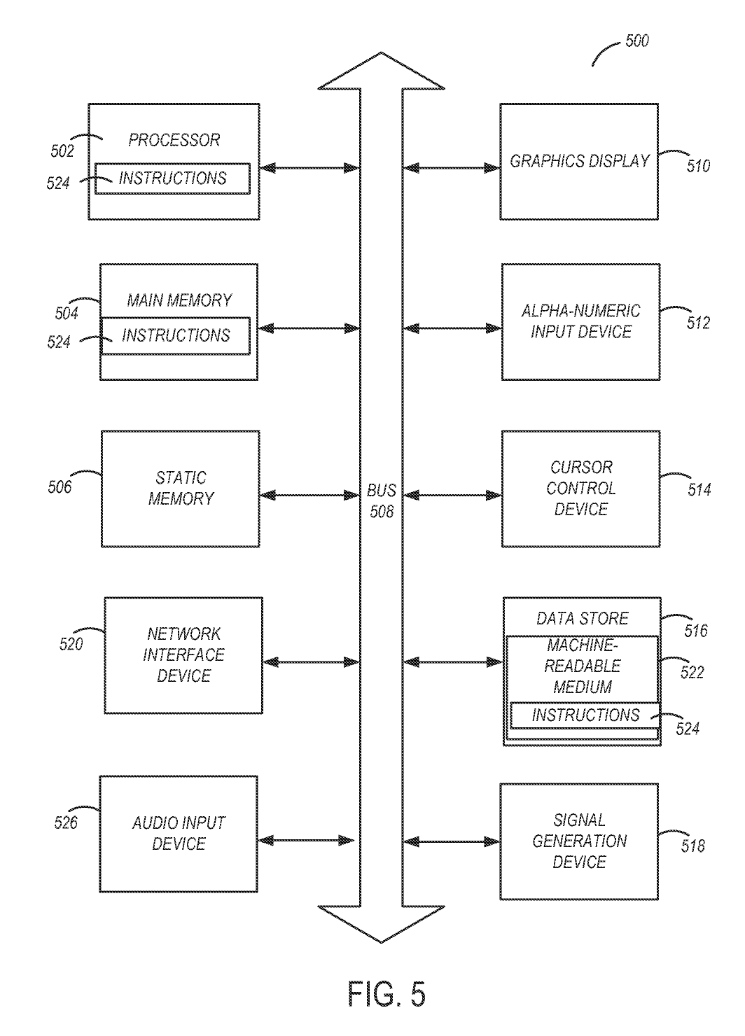

FIG. 5 is a block diagram illustrating components of an example machine able to read instructions from a non-transitory machine-readable medium and execute those instructions in a processor to perform the machine processing tasks discussed herein, such as the operations discussed above for the servers 102, the storage devices 104, the TAP patch panel 108, the monitoring system 110, and the information system 112. Specifically, FIG. 5 shows a diagrammatic representation of a machine in the example form of a computer system 500 within which instructions 524 (e.g., software) for causing the machine to perform any one or more of the methodologies discussed herein may be executed. In alternative embodiments, the machine operates as a standalone device or may be connected (e.g., networked) to other machines, for instance via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include graphics display unit 510 (e.g., a plasma display panel (PDP), a liquid crystal display (LCD), a projector, or a cathode ray tube (CRT)). The computer system 500 may also include alphanumeric input device 512 (e.g., a keyboard), a cursor control device 514 (e.g., a mouse, a trackball, a joystick, a motion sensor, or other pointing instrument), a data store 516, a signal generation device 518 (e.g., a speaker), an audio input device 526 (e.g., a microphone) and a network interface device 520, which also are configured to communicate via the bus 508.

The data store 516 includes a non-transitory machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network (not shown) via network interface 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors as described above in connection with FIG. 5. Alternatively, hardware or software modules may be stored elsewhere within a computing system.

As referenced herein, a computer or computing system includes hardware elements used for the operations described here regardless of specific reference in FIG. 5 to such elements, including for example one or more processors, high speed memory, hard disk storage and backup, network interfaces and protocols, input devices for data entry, and output devices for display, printing, or other presentations of data. Numerous variations from the system architecture specified herein are possible. The components of such systems and their respective functionalities can be combined or redistributed.

### Additional Considerations

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

It is appreciated that the particular embodiment depicted in the figures represents but one choice of implementation. Other choices would be clear and equally feasible to those of skill in the art.

While the disclosure herein has been particularly shown and described with reference to a specific embodiment and various alternate embodiments, it will be understood by persons skilled in the relevant art that various changes in form and details can be made therein without departing from the spirit and scope of the disclosure.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience. This description should be read to include one or at least one and the singular also includes the plural unless it is obvious that it is meant otherwise.

Upon reading this disclosure, those of skill in the art will appreciate still additional alternative structural and functional designs for efficiently tracking network transactions over time through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
maintaining, by the computer system, a plurality of counts, each of the plurality of counts associated with a time range for the duration of network transactions;
identifying, by a computer system, a network transaction between devices in a storage area network;
determining, by the computer system, a time duration for the identified network transaction;
identifying, by the computer system from the plurality of counts, a count associated with a time range that includes the determined duration; and
incrementing, by the computer system, the identified count.

2. The method of claim 1, wherein the identified count indicates a number of network transactions that occurred during a time period with time durations that are within the time range.

3. The method of claim 1, further comprising:
responsive to the end of a time period being reached, transmitting a value of each of the plurality of counts to an information system for storage and resetting the plurality of counts.

4. The method of claim 1, wherein the count is identified based on the count being associated with a type of the identified network transaction.

5. The method of claim 1, wherein the identified network transaction is a read exchange completion transaction and the time duration is an amount of time for a first device in the storage area network to read an item from a second device.

6. The method of claim 1, wherein the identified network transaction is a write exchange completion transaction and the time duration is an amount of time for a first device in the storage area network to store an item responsive to a second device issuing a write request for the item.

7. The method of claim 1, wherein the time duration of the identified network transaction is an amount of time between a first device in the storage area network issuing a read request for an item to a second device and the first device receiving a first packet of the item from the second device.

8. The method of claim 1, wherein the time duration of the identified network transaction is an amount of time between a first device in the storage area network issuing a write request for an item to a second device and the second device storing a first packet of the item.

9. The method of claim 1, wherein the network transaction is identified based on the analysis of signals traveling on a communication channel in the storage area network and diverted to the computer system.

10. The method of claim 9, wherein the signals are optical signals diverted to an optical fiber connected to the computer system.

11. A computer-implemented method comprising:
maintaining a plurality of counts, each of the plurality of counts associated with a size range for the size of network transactions;
identifying a network transaction between devices in a storage area network;
determining a size of the identified network transaction;
identifying, from the plurality of counts, a count associated with a size range that includes the determined size; and
incrementing the identified count.

12. The method of claim 11, wherein the identified count indicates a number of network transactions that occurred during a time period with sizes that are within the size range.

13. The method of claim 11, further comprising:
responsive to the end of a time period being reached, transmitting a value of each of the plurality of counts to an information system for storage and resetting the plurality of counts.

14. The method of claim 11, wherein the count is identified based on the count being associated with a type of the identified network transaction.

15. The method of claim 11, wherein the identified network transaction is a read exchange completion transaction.

16. The method of claim 11, wherein the identified network transaction is a write exchange completion transaction.

17. The method of claim 11, wherein the network transaction is identified based on the analysis of signals traveling on a communication channel in the storage area network and diverted to a computer system.

18. A computer-implemented method comprising:
maintaining a plurality of counts, each of the plurality of counts associated with a range;
identifying a network transaction between devices in a storage area network;
determining a metric of the identified network transaction;
identifying, from the plurality of counts, a count associated with a range that includes the determined metric; and
incrementing the identified count.

19. The method of claim 18, wherein the identified count indicates a number of network transactions that occurred during a time period with metrics that are within the range.

20. The method of claim 18, further comprising:
responsive to the end of a time period being reached, transmitting a value of each of the plurality of counts to an information system for storage and resetting the plurality of counts.
